(19) United States
(12) Patent Application Publication
(10) Pub. No.: US 2021/0186670 A1
(43) Pub. Date: Jun. 24, 2021

(54) COMPOSITE POLISHING STRAND AND METHOD OF USING SAME

(71) Applicant: Brian Gray, Arlington, VA (US)

(72) Inventor: Brian Gray, Arlington, VA (US)

(21) Appl. No.: 16/718,261

(22) Filed: Dec. 18, 2019

(51) Int. Cl. A61C 17/00; A61C 15/04; A61C 5/20

(52) U.S. Cl. CPC A61C 17/00; A61C 15/041; A61C 5/20; A61C 15/045; A61C 15/043

(57) ABSTRACT

A composite polishing strand has a polishing strip for polishing a dental restoration, such as a filling, and may incorporate a floss leader coupled to a polishing strip. The floss leader may be snapped down between teeth and the polishing strip may then be pulled into the interproximal contact area for polishing a dental restoration. A composite polishing strip may also include a threader having an insert end that can be inserted into an interproximal contact area, such as an interproximal subjacent contact area, and pushed through to the opposing side. The threader may then be pulled to locate the polishing strip in the interproximal contact area for polishing the dental restoration. The composite polishing strip having both a threader and floss leader enables two different methods of locating the polishing strip in the interproximal contact area and therefore is very versatile.

### BACKGROUND OF THE INVENTION

### Field of the Invention

The invention relates to a composite polishing strand having a polishing strip for polishing a dental restoration, such as a filling, and method's of using the composite polishing strand.

### Background

Dental restorations, such as a filling, require the filling to be polished to remove any course material or flanges that can promote and increase bacteria and cavity formation. Often times the dental restoration is configured in an interproximal contact area making access difficult, especially for a relatively thick and bulky polishing strip.

### SUMMARY OF THE INVENTION

The invention is directed to a composite polishing strand having a polishing strip for polishing a dental restoration, such as a filling, and methods of using the composite polishing strand. An exemplary composite polishing strand has a floss leader coupled to a polishing strip. The floss leader may be snapped down between teeth and the polishing strip may then be pulled into the interproximal contact area for polishing a dental restoration. An exemplary composite polishing strip may also comprise a threader having an insert end that can be inserted into an interproximal contact area, such as an interproximal subjacent contact area, and pushed through to the opposing side. The threader may then be pulled to locate the polishing strip in the interproximal contact area for polishing the dental restoration. An exemplary composite polishing strip comprising a threader and floss leader enables two different methods of locating the polishing strip in the interproximal contact area and therefore is very versatile. Each of the components of the composite polishing strand, the polishing strip, floss leader and threader are structurally different and serve a unique purpose.

An exemplary composite polishing strip may comprise a plurality of composite polishing strand segments, each of which comprising a polishing strip and at least a floss leader. In some embodiments, each of the composite polishing strand segments also comprise a threader. The composite polishing strand segments may be configured in a continuous strand that may be cut into individual composite polishing strand segments. For example, the coupled composite polishing strand segments may be configured in a spool and an individual composite polishing strand segment may be cut off to produce a separated composite polishing strand segment

An exemplary composite polishing strip may be used to polish any number of different types of dental restorations including, fillings, luting cement used for crowns and the like. A polishing strip may be used to polish filling materials, adhesives and cements, porcelain, other restorative materials and the like.

An exemplary polishing strip of a composite polishing strip may comprise one or more abrasive portions. Each of the abrasive portions may have different roughness, or abrasive properties and may contain different abrasive materials or different concentrations or sized abrasives. In an exemplary embodiment, a polishing strip comprises two abrasive portions, a rough abrasive portion and a finer abrasive portion, wherein the rough abrasive portion may have a surface roughness that is at least twice that of the finer abrasive portion. An exemplary polishing strip may be a length that is effective for moving the polishing strip along a dental restoration to abrade away flanges and polish the dental restoration, and may have a length of about 4 inches or more, 5 inches or more, 6 inches or more, 7 inches or more, 8 inches or less, or from about 4 inches to 8 inches and any other range between and including the length values provided.

An exemplary polishing strip may have any suitable type of abrasive for dental use including silica, silica oxide, silicon carbide, aluminum oxide, diamond and the like. The roughness of an exemplary polishing strip may vary depending on the application. A course polishing strip may be used initially, followed by a medium roughness and finally by a fine or superfine polishing strip. The Ra values of an exemplary polishing strip may be about 0.1 or more, about 0.2 or more, about 0.4 or more, about 0.6 or more, about 0.8, of from about 0.1 to about 1.0 and any other range between and including the Ra values provided. An Ra value may be measured using a surface roughness profilometer from Phase II, Upper Saddle River, N.J., such as models SRG-4600, SRG-2000, or SRG-4000.

Thickness of the polishing strip may correlate with the roughness of the strip and may be about 0.05 to about 0.5 mm. The less abrasive polishing strips may be about 0.05 to about 0.08 mm thick and may be yellow in color. The medium coarseness polishing strip may be about 0.08 mm to about 0.15 mm or 0.2 mm thick, and may be red in color. The heavy and most coarse polishing strip may be about 0.2 mm to about 0.25 mm thick, or to about 0.5 mm thick and may be green in color. The polishing strip may not be able to fit between the tight gaps in the teeth as the polishing strip is too thick and the abrasive materials are hard and incompressible. A polishing strip may not be able to slide down between a gap of about 0.03 mm or less, or about 0.05 mm or less, or about 0.8 mm or less.

A polishing strip may comprise an abrasive material configured on a flat support, such as a polymeric or metallic tape having a width that is at least five times greater than the thickness. The width of an exemplary polishing strip may be about 1.5 mm or more, about 1.75 mm or more, about 2.0 mm or more, about 3 mm or more, about 3.5 mm or more, about 4 mm or more, about 5 mm or more, or from about 1.5 mm to about 4 mm and any other range between and including the width values provided,

An exemplary floss leader may be smaller in cross-length dimension, or width, than a polishing strip which enables the floss leader to be snapped down between teeth and between a dental restoration and an adjacent tooth. These spaces may be very tight and a polishing strip may not be able to pulled down through these tight gaps due to the thickness and width of the polishing strip. An exemplary floss leader may also be compressible, wherein the thickness can be compressed as it slides down between tight gaps. Polymeric materials and especially porous polymeric materials, such as expanded polytetrafluoroethylene (PTFE) are compressible. The thickness of an exemplary floss may be about 0.1 mm or less, about 0.075 mm or less, about 0.05 mm or less and any range between and including the thickness values provided. An exemplary floss leader may be able to be pulled down between a gap of about 0.03 mm or less, or about 0.05 mm or less, or about 0.8 mm or less.

A floss leader may have a length to enable opposing ends to be held and pulled down into an interproximal contact area and may be about flinches or more, about 5 inches or more, about 6 inches or more, 7 inches or more, 8 inches or less, or from about 4 inches to 8 inches and any other range between and including the length values provided. An exemplary floss leader may be polymeric and comprise or be made out of nylon or fluoropolymer, such as polytetrafluoroethylene (PTFE) and may contain a coating, such as wax.

An exemplary floss leader is a flexible and supple extension of material that enables it to be wound around the fingers for snapping it down between teeth. An exemplary floss leader is not free-standing as defined herein. When held horizontally, an exemplary floss leader will bend under the weight of the floss leader. An exemplary floss leader may include a single filament or tape of material or may comprise two or more filaments or taps that are coupled, such as by twisting, about each other.

An exemplary threader may be stiff and free-standing, whereby the threader retains an elongated straight shape when held horizontally. An exemplary threader may be a polymeric material that is coated with a stiffening material, such as a wax or other polymeric material. An exemplary threader may be shorter in length than the floss leader or polishing strip as it only has to extend through the interproximal contact area from one side of adjacent teeth to the opposing side. An exemplary threader may have a length of about 2 inches or more, about 3 inches or more, about 4 inches or more, about 5 inches or less, from about 2 inches to 4 inches and any other range between and including the length values provided.

An exemplary composite polishing strip may comprise continuous portions, such as a filament or tape that extends over two or more portions of the composite polishing strip. For example, the threader and floss leader may be formed from continuous filament or filaments or tape of material and the threader may have an additional stiffening material coated therein to make the threader portion free-standing. Likewise, a floss leader and polishing strip may be formed from a continuous filament or filaments or tape of material and the polishing strip portion may have abrasive materials attached thereto.

An exemplary container may comprise a spool of a composite polishing strip having a plurality of composite polishing strand segments. Successive polishing strips may be coupled together by floss leaders and in some cases a threader therebetween. A container may have a cutting implement, such as a small blade or sharp edge that the composite polishing strip can be pulled over and cut, such as between floss leaders or along the threader to produce a separated composite polishing ship. A spool of a composite polishing strip may have an indicator mark, such as a colored mark such as a line or dot to indicate a transition between polishing strand segments and/or a location for cutting off a polishing strand segment from the spool. As described, a polishing strand segment may have individual segments of different abrasive, such as light, medium and heavy and an indicator mark may be configured between each segment of abrasive or between a grouping of segments, whereby a segment has two or more abrasive types. When a spool is configured with a threader, the threader may have an indicator mark and the threader may be cut along the length of the threader, thereby providing a portion of threader for the next cut segment.

An exemplary composite polishing strip may include polishing strips that have different roughness, wherein a first polishing strip of a first composite polishing strip segment has a first roughness and wherein a second polishing strip of a second composite polishing ship segment has a second roughness that is substantially different from the first roughness value, or at least 20% different. In some cases, the polishing stops or a portion of the composite polishing strip segment thereof is color coded for the roughness of the polishing strip. For example, yellow may indicate the finest or lease roughness polishing strip and green may indicate the most coarse polishing strip having the highest roughness. Other colors may be used to indicate intermediate roughness polishing strips, such as red and blue. A red color may be more rough than the yellow and blue may be more rough than red, for example.

A method of using an exemplary composite polishing strip includes snapping a floss leader between adjacent teeth and down into the interproximal contact area. The floss leader can then be pulled through the interproximal contact area to locate the polishing strip in the interproximal contact area and along a dental restoration. The polishing strip may then be moved back and forth to polish the dental restoration. Again, the polishing strip may comprise a first and second abrasive portion, whereby a first more coarse abrasive portion may be used before the finer abrasive portion is used for final polishing.

In another exemplary method a composite polishing strip comprises a threader and the threader is pushed through an interproximal contact area and the composite polishing strip is pulled to located the polishing strip in the interproximal contact area and along a dental restoration.)

An exemplary composite polishing strip comprising both a floss leader and threader enables both methods described above to be used and makes the composite polishing strip a versatile implement for dental restoration polishing.

The summary of the invention is provided as a general introduction to some of the embodiments of the invention, and is not intended to be limiting. Additional example embodiments including variations and alternative configurations of the invention are provided herein.

### BRIEF DESCRIPTION OF SEVERAL VIEWS OF THE DRAWINGS

The accompanying drawings are included to provide a further understanding of the invention and are incorporated in and constitute a part of his specification, illustrate embodiments of the invention, and together with the description serve to explain the principles of the invention.

FIG. 1 shows a side view of an exemplary composite polishing strand comprising a polishing strip, a floss leader and a threader.

FIG. 2 shows cross sections of the exemplary composite polishing strand along the polishing strip, floss leader and threader.

FIG. 3 shows a side view of an exemplary composite polishing strand comprising a pair of polishing composite polishing strand segments, each comprising a polishing strip, a floss leader and a threader.

FIG. 4 shows a side view of a container having an exemplary composite polishing strand comprising a plurality of composite polishing strand segments that are configured for separation between adjacent threaders segments.

FIG. 5 shows a side view of a dental restoration between two adjacent teeth and an exemplary composite polishing strand configured overtop of the interproximal contact area.

FIG. 6 shows a top view of a dental restoration between two adjacent teeth and an exemplary composite polishing strand being snapped down into the interproximal contact area of the two adjacent teeth.

FIG. 7 shows a side view of a dental restoration having a dental restoration flange, and the floss leader portion of an exemplary composite polishing strand configured in the interproximal subjacent contact area.

FIG. 8 shows a top view of a dental restoration between two adjacent teeth and an exemplary polishing strip configured in the interproximal contact area of the two adjacent teeth to polish the dental restoration.

FIG. 9 shows a side view of a dental restoration between two adjacent teeth and a polishing trip of an exemplary composite polishing strand configured in the interproximal subjacent contact area to polish away the dental restoration flange from the dental restoration.

FIG. 10 shows a side view of a dental restoration after being polished with an exemplary composite polishing strand

FIG. 11 shows a side view of a dental restoration between two adjacent teeth and an exemplary composite polishing strand configured with a threader in the interproximal subjacent contact area.

FIG. 12 shows a top view of a dental restoration between two adjacent teeth and an exemplary composite polishing strand being inserted through the interproximal subjacent contact area by the threader.

Corresponding reference characters indicate corresponding parts throughout the several views of the figures. The figures represent an illustration of some of the embodiments of the present invention and are not to be construed as limiting the scope of the invention in any manner. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention

### DETAILED DESCRIPTION OF THE ILLUSTRATED EMBODIMENTS

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Certain exemplary embodiments of the present invention are described herein and are illustrated in the accompanying figures. The embodiments described are only for purposes of illustrating the present invention and should not be interpreted as limiting the scope of the invention. Other embodiments of the invention, and certain modifications, combinations and improvements of the described embodiments, will occur to those skilled in the art and all such alternate embodiments, combinations, modifications, improvements are within the scope of the present invention.

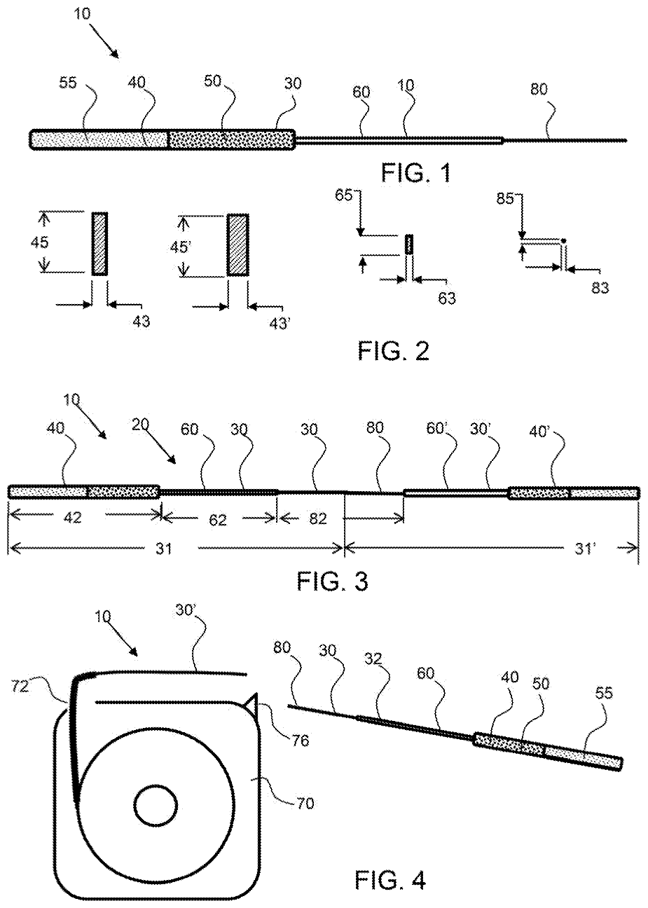

As shown in FIG. 1, an exemplary dental restoration polishing assembly 1 comprises a composite polishing strand 20 comprising a polishing strip 40, a floss leader 60 and a threader 80. The polishing strip has a first abrasive portion 50 and a second abrasive portion 55. The floss leader 60 is configured between the threader and the polishing strip. As shown, the polishing strip is thicker than the floss leader.

FIG. 2 shows cross sections of the exemplary composite polishing strand shown in FIG. 1 and the widths of each of the different portions of the composite polishing strand. The polishing strip 40 has two different abrasive portions having different Re surface roughness values and different thicknesses, 43, and 43′. The widths 45, 45′ of the two portions of the polishing strip may be the same or different. As shown, the first abrasive portion 50 is substantially thicker that the second abrasive portion 55, wherein it is at least 20% greater in thickness. The floss leader 60 has a thickness 63 and width 65 that is less than half that of the polishing strip 40 which enables the floss leader to be snapped down through tight gaps in teeth. The threader 80 has a very small width 85 and thickness 83, which may be half or less that of the floss leader. The length of the polishing strip 42 may be greater than the length 62 of the floss leader 60 and the floss leader length may be greater than the length 82 of the threader. Note that the length of the threader in use, after splicing or cutting may be about half the length 82 of the threader as shown.

As shown in FIG. 3, an exemplary composite polishing strand 20 comprises a pair of composite polishing strand segments 30, 30′, each comprising a polishing strip 40, a floss leader 60 and a threader 80. The two composite polishing strand segments are coupled together by a threader 80 and this threader may be cut to produce a threader for each of the composite polishing strand segments, as shown in FIG. 4. The segment lengths 31, 31′ for two consecutive strand segments 30, 30′ is shown in FIG. 3, wherein the two segments are coupled together by a threader 80.

As shown in FIG. 4, an exemplary composite polishing strand 20 comprises a plurality of composite polishing strand segments 30 spooled into a spool and retained in a container 70. Each of the composite polishing strands 20 polishing strip 40, a floss leader 60 and a threader 80. As shown, the composite polishing strand 20 is pulled out from the container through the outlet opening 72 and a composite polishing strand segment 30 is cut by the cutting implement 76 to produce a separated composite polishing strand segment 32. The composite polishing strand segments 30 is separated along the threader to provide a threader on the separated composite polishing strand segment 32 and to leave a threader on the spool attached composite polishing strand segments 30′. The spool of composite polishing strand segments 30 may contain a plurality of composite polishing strand segments as described herein.

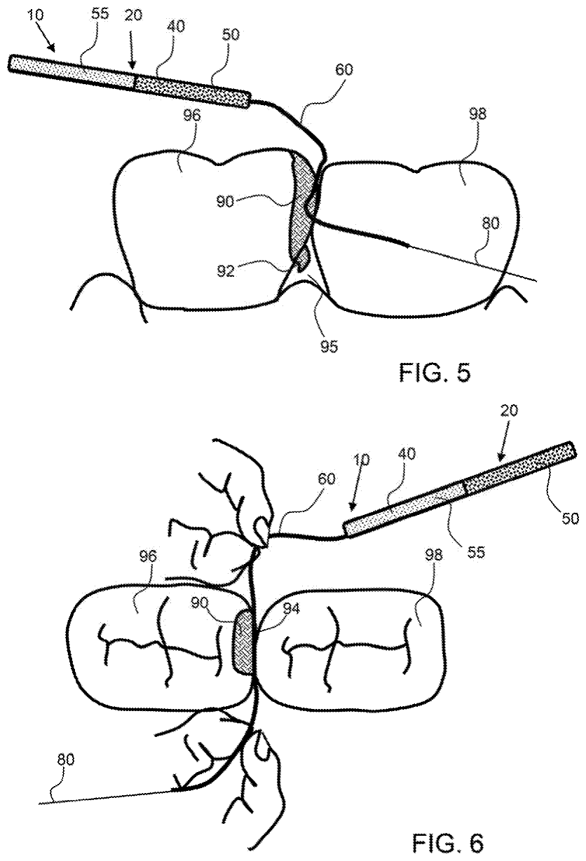

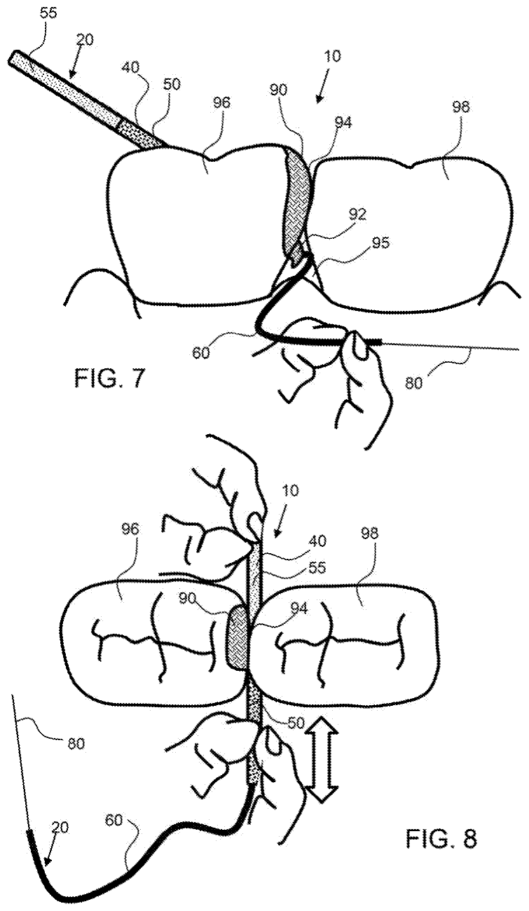

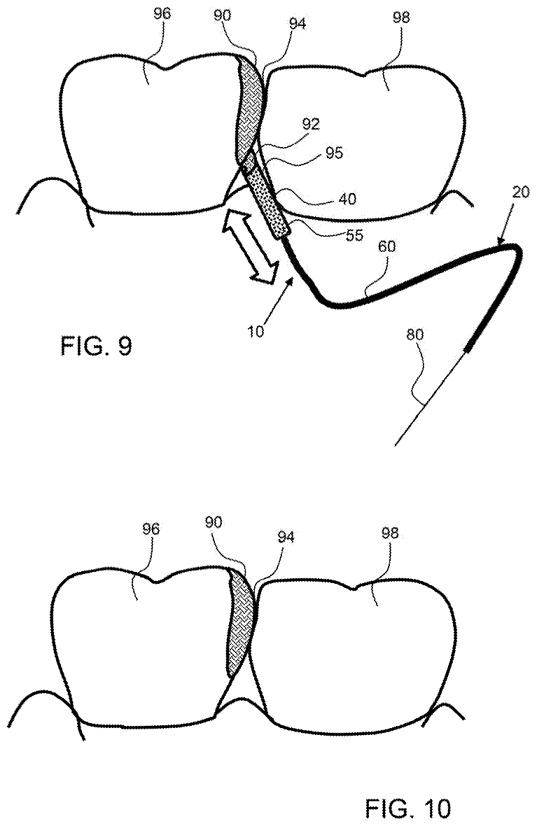

Referring now to FIGS. 5 to 9, the floss leader 60 portion of an exemplary composite polishing strand 20 is configured between two adjacent teeth and snapped down into an interproximal contact area between the two teeth. A dental restoration 90, such as a filling, is in the interproximal contact area 94 of the first tooth 96, proximal to the second tooth 98. A dental restoration flange 92 extends into the interproximal subjacent contact area 95. As shown in FIG. 6, the floss leader 60 extends over the two teeth and is pulled and snapped down between the teeth and into the interproximal subjacent contact area. As shown in FIG. 7, the composite polishing strand 20 is pulled to located the polishing strip 40 in the interproximal subjacent contact area, as shown in FIG. 8. As shown in FIGS. 8 and 9, the polishing strip is moved back and forth over the dental restoration 90 and particularly over a dental restoration flange 92.

As shown in FIG. 10, the exemplary composite polishing strand 20 has polished the dental restoration and has removed the dental restoration flange 92.

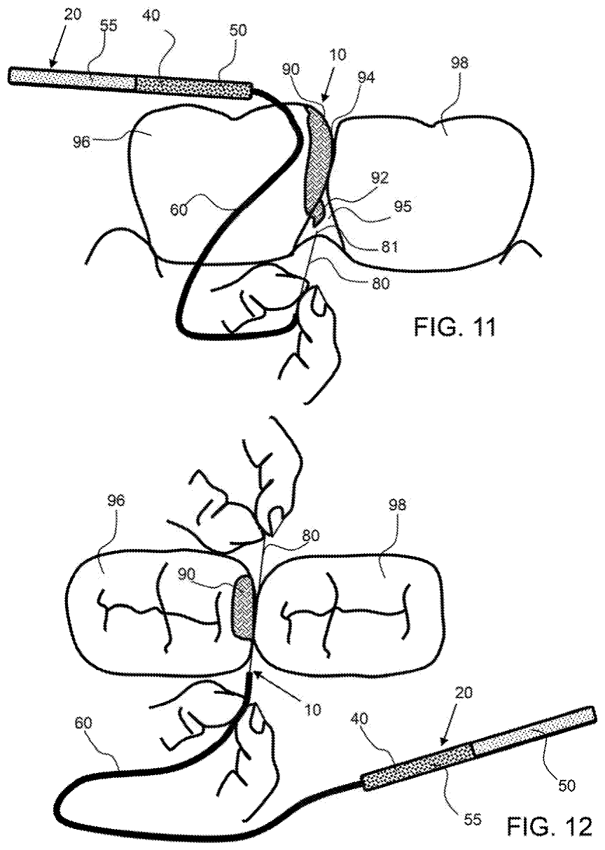

Referring to FIGS. 11 and 12, the insert end 81 of a threader 80 portion of an exemplary composite polishing strand 20 is configured between two adjacent teeth and pushed through the interproximal contact area 94, into the interproximal subjacent contact area 95. As shown in FIG. 11, the threader is pulled through the interproximal contact area 94. The floss leader 60 may be pulled through the interproximal contact area to locate the polishing strip 40 in the interproximal contact area and against a dental restoration 90. The polishing strip may then be moved back and forth over the dental restoration and any dental restoration flanges 92 to polish the dental restoration and remove any flanges, as shown in FIGS. 8 and 9. The polishing strip may have a first abrasive portion 50 and a second abrasive portion 55.

It will be apparent to those skilled in the art that various modifications, combinations and variations can be made in the present invention without departing from the scope of the invention. Specific embodiments, features and elements described herein may be modified, and/or combined in any suitable manner. Thus, it is intended that the present invention cover the modifications, combinations and variations of this invention provided they come within the scope of the appended claims and their equivalents.

What is claimed is:

1. A dental restoration polishing assembly comprising a composite polishing strand comprising a composite polishing strand segment comprising:
a) a floss leader portion comprising:
i) a floss leader thickness that enables the floss leader to be snapped down between a gap of 0.05 mm;
ii) a floss leader length; and
iii) a polishing strip interface end:
b) a polishing strip coupled to the floss leader on said polishing strip interface end, wherein said polishing strip comprises:
i) an abrasive:
ii) a polishing strip thickness; and
iii) a polishing strip length;
wherein the polishing strip cannot be snapped down between a gap of 0.05 mm.

2. The dental restoration polishing assembly of claim 1, wherein the floss leader thickness is less than 0.05 mm and wherein the polishing strip thickness is greater than 0.08 mm.

3. The dental restoration polishing assembly of claim 1, comprising a plurality of a polishing strand segments coupled together by the floss leader, wherein the floss leader has a polishing strip coupled to opposing ends of the floss leader.

4. The dental restoration polishing assembly of claim 3, further comprising a container wherein the composite polishing strand is configured as a spool in said container having said plurality of composite polishing strand segments spooled about each other.

5. The dental restoration polishing assembly of claim 4, wherein the container has an outlet opening and a cutting feature to cut the floss leader to produce a separated polishing strand segment.

6. The dental restoration polishing assembly claim 1, wherein the floss leader comprises a threader interface end and wherein the composite polishing strand further comprises:
c) a threader coupled to the floss leader on a threader interface end of the floss leader, said threader comprising:
i) a threader width; and
ii) a threader length;
wherein said threader is stiff and free-standing.

7. The dental restoration polishing assembly claim 6, comprising a plurality of a polishing strand segments coupled together by the threader, wherein a floss leader of a first polishing strand segment is coupled to a first end of the threader and a second floss leader is coupled to a second end of the threader.

8. The dental restoration polishing assembly of claim 7, further comprising a container wherein the composite polishing strand is configured as a spool in said container having said plurality of composite polishing strand segments spooled about each other.

9. The dental restoration polishing assembly of claim 8, wherein the container has an outlet opening and a cutting implement to cut the threader to produce a separated polishing strand segment.

10. The dental restoration polishing assembly claim 1, wherein the polishing strip comprises:
a first abrasive portion having a first abrasive; and
a second abrasive portion having a second abrasive;
wherein the first abrasive second abrasive are different abrasives.

11. The dental restoration polishing assembly claim 1, wherein the polishing strip comprises:
a first abrasive portion having a Re roughness; and
a second abrasive portion having a Ra roughness;
wherein the first abrasive Re roughness and second abrasive Re roughness are at least 20% different.

12. The dental restoration polishing assembly claim 1, wherein the polishing strip has a width that is at least 50% greater than a floss leader width.

13. The dental restoration polishing assembly claim 1, wherein the polishing strip length is greater than the floss leader length.

14. The dental restoration polishing assembly claim 1, wherein the floss leader length is at least double the threader length.

15. The dental restoration polishing assembly claim 1, wherein the floss leader width is at least 50% greater than the threader width.

16. The dental restoration polishing assembly claim 1, wherein the floss leader width is at least double the threader width

17. The dental restoration polishing assembly claim 1, wherein the floss leader length is at least 50% greater than the threader length.

18. The dental restoration polishing assembly claim 1, wherein the floss leader length is at least double the threader length.

19. A method of polishing a dental restoration comprising providing a dental restoration polishing assembly as described in claim 1:
a) configuring the floss leader over an interproximal contact area between a first tooth having said dental restoration and a second tooth directly adjacent to the first tooth;
b) pulling the floss leader down into the interproximal contact area between the first tooth and the second tooth;
c) pulling the floss leader to locate the polishing strip in the interproximal contact area;
d) moving the polishing strip back and forth over the dental restoration to polish the dental composite restoration.

20. The method of claim 19, wherein the composite polishing strand comprises a plurality of composite polishing strand segments and wherein the method comprises separating a polishing strand segment from the plurality of composite polishing strand segments to produce a separated polishing strand segments for use in said method.

21. The method of claim 20, wherein dental restoration polishing assembly further comprises a container wherein the composite polishing strand is configured as a spool in said container having said plurality of composite polishing strand segments spooled about each other;
wherein the container has an outlet opening and a cutting feature to cut the floss leader to produce a separated polishing strand segment; and
wherein the method further comprises pulling and separating a composite polishing strand segment from the container to produce a separated composite polishing strand segment for use is said method.

22. A method of polishing a dental restoration comprising:
a) providing a composite polishing strand assembly comprising a composite polishing strand comprising a composite polishing strand segment comprising:
i) a floss leader portion comprising:
a floss leader thickness that enables the floss leader to be snapped down between a gap of 0.05 mm;
a floss leader length; and
a polishing strip interface end;
a threader interface end;
ii) a polishing strip coupled to the floss leader on said polishing strip interface end, wherein said polishing strip comprises:
an abrasive;
a polishing strip thickness; and
a polishing strip length;
wherein the polishing strip cannot be snapped down between a gap of 0.05 mm,
iii) a threader coupled to the floss leader on the threader interface end of the floss leader, said threader comprising:
a threader width:
a threader length; and
an insert end;
wherein said threader is stiff and free-standing
b) configuring the insert end of the threader in an interproximal subjacent contact area between a first tooth having said dental restoration and a second tooth directly adjacent to the first tooth;
c) pushing the threader through the interproximal contact area between the first tooth and the second tooth:
d) pulling the threader to locate the polishing strip in the interproximal contact area:
e) moving the polishing strip back and forth over the dental restoration to polish the dental composite restoration.

23. The method of claim 22 wherein the composite polishing strand comprises a plurality of composite polishing strand segments and wherein the method comprises separating a polishing strand segment from the plurality of composite polishing strand segments to produce a separated polishing strand segments for use in said method.

24. The method of claim 23, wherein the composite polishing strand assembly further comprises a container;
wherein the composite polishing strand is configured as a spool in said container having said plurality of composite polishing strand segments spooled about each other;
wherein the container has an outlet opening and a cutting feature to cut the floss leader to produce a separated polishing strand segment; and
wherein the method further comprises pulling and separating a composite polishing strand segment from the container to produce a separated composite polishing strand segment for use is said method.
